(19) United States
(12) Patent Application Publication
(10) Pub. No.: US 2014/0160573 A1
(43) Pub. Date: Jun. 12, 2014

(54) LENS ARRAY, IMAGE-FORMING APPARATUS AND IMAGE-READING APPARATUS INCLUDING LENS ARRAY

(71) Applicant: CANON KABUSHIKI KAISHA, Tokyo (JP)

(72) Inventors: Masayasu Teramura, Utsunomiya-shi (JP); Yoshihiro Ishibe, Utsunomiya-shi (JP); Takeyoshi Saiga, Tokyo (JP)

(73) Assignee: CANON KABUSHIKI KAISHA, Tokyo (JP)

(21) Appl. No.: 14/095,799

(22) Filed: Dec. 3, 2013

(30) Foreign Application Priority Data
Dec. 7, 2012 (JP) 2012-268544

(51) Int. Cl. G02B 27/10; G03G 15/04

(52) U.S. Cl. CPC G03G 15/04; G02B 3/0037
USPC 359/619; 399/218

(57) ABSTRACT

A lens array includes a first image-forming unit having a plurality of lens portions arrayed in a first direction and configured to form an intermediate image of an object at an intermediate image plane; and a second image-forming unit having a plurality of lens portions arrayed in the first direction and configured to re-image the intermediate image of the object onto a final image plane. The plurality of lens portions of the first and second image-forming units each have an anamorphic surface on a lens surface closest to the intermediate image plane, and each anamorphic surface has a shape having a decreased power at end portions as compared to a power in the vicinity of a surface vertex.

### BACKGROUND OF THE INVENTION

1. Field of the Invention

This disclosure relates to a lens array, and is suitable for a lens array used, for example, in image-forming apparatuses or image-reading apparatuses.

2. Description of the Related Art

In recent years, image-forming apparatuses and image-reading apparatuses using a lens array composed of a plurality of lenses have been developed. In this configuration, reductions in size and cost of the apparatus more than a configuration of scanning a photosensitive member by a polygon mirror or a configuration of reading images by using plurality of lenses or mirrors are realized.

In patent application publication US2005/0002105, an image-reading apparatus using a lens array formed of a resin is disclosed. In patent application publication US2009/0067055, a lens array formed with an aspherical surface in rotational symmetry for correcting a spherical aberration is disclosed.

When an attempt is made to reduce a light-emitting amount to improve a lifetime of a light source in the above-described apparatuses, a light use efficiency of the lens array needs to be increased as well. However, when the light use efficiency of the lens array is increased in design in the configurations in US2005/0002105 and US2009/0067055, an image-forming performance is lowered specifically due to generation of a field curvature or an astigmatic difference.

### SUMMARY OF THE INVENTION

This disclosure is directed to a lens array which corrects the field curvature and the astigmatic difference and achieves both high light use efficiency and improved image-forming performance.

According to an aspect of the present invention, a lens array includes: a first image-forming unit having a plurality of lens portions arrayed in a first direction and configured to form an intermediate image of an object at an intermediate image plane; and a second image-forming unit having a plurality of lens portions arrayed in the first direction and configured to re-image the intermediate image of the object onto a final image plane, wherein the plurality of lens portions of the first and second image-forming units each have an anamorphic surface on a lens surface closest to the intermediate image plane, and wherein each anamorphic surface has a shape having a decreased power at end portions as compared to a power in the vicinity of a surface vertex.

Further features of the present invention will become apparent from the following description of exemplary embodiments with reference to the attached drawings.

### BRIEF DESCRIPTION OF THE DRAWINGS

FIGS. 1A to 1C are schematic drawings illustrating a principal portion of a lens array of Example 1.

FIGS. 2A and 2B are graphs showing field curvatures of a comparative example and Example 1.

FIGS. 3A and 3B are drawings showing point image distributions of the comparative example and Example 1.

FIGS. 4A and 4B are drawings illustrating optical paths of light beams from respective object heights of Example 1.

FIGS. 5A to 5D are graphs for explaining a shape of an anamorphic surface of Example 1.

FIGS. 6A to 6C are schematic drawings illustrating a principal portion of a lens array of Example 2.

FIGS. 7A and 7B are drawings illustrating optical paths of light beams from respective object heights of Example 2.

FIGS. 8A to 8D are drawings for explaining a shape of an anamorphic surface of Example 2.

FIG. 9 is a graph showing field curvatures of Example 2.

FIG. 10 is a drawing showing point image distributions of Example 2.

FIG. 11 is a schematic drawing of a principal portion of an image-forming apparatus according to an embodiment of this disclosure.

FIG. 12 is a schematic drawing illustrating a principal portion of a color image-forming apparatus of an embodiment of this disclosure.

### DESCRIPTION OF THE EMBODIMENTS

A lens array of embodiments disclosed here includes first and second image-forming units having a plurality of lens portions arrayed in a first direction, and lens surfaces of the respective lens portions closest to an intermediate image-forming surface are formed into an anamorphic surface. The power of the anamorphic surface decreases from a vicinity of a surface vertex toward end portions, whereby desirable corrections of a field curvature and an astigmatic difference are enabled while increasing light use efficiency.

In the lens array of the embodiment disclosed here, a phenomenon in which a numerical value of power as an inverse of a focal distance decreases is expressed as “the power decreases”. In other words, the expression “the power decreases” includes a case where the power is changed from a strong positive power to a weak positive power, a case where the power is changed from a positive power to a negative power, and a case where the power is changed from a weak negative power to a strong negative power.

Referring now to the drawings, preferred embodiments of this disclosure will be described in detail, by referring to specific examples set forth below.

### Example 1

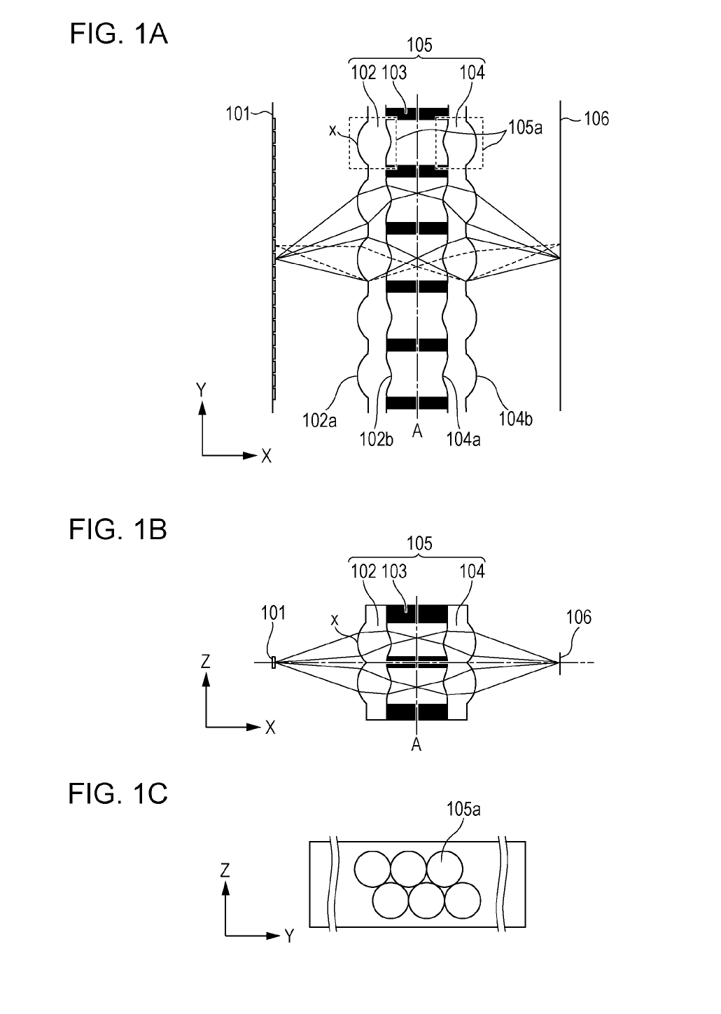

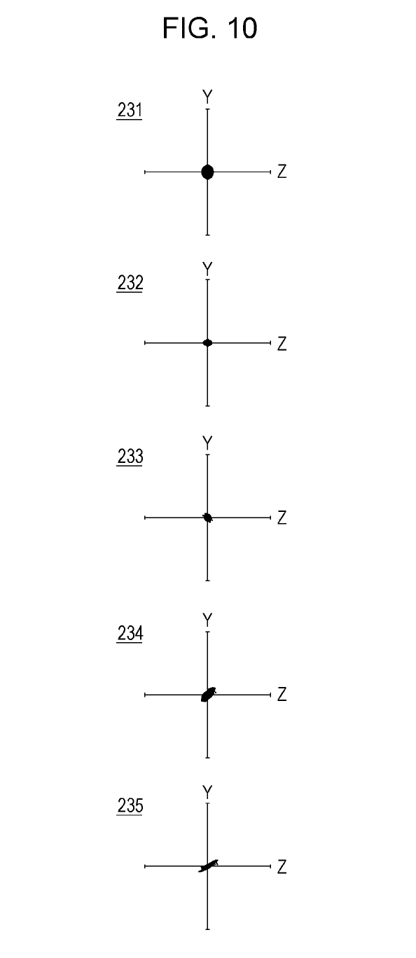

FIGS. 1A, 1B and 1C are schematic drawings of a principal portion of a lens array 105 of Example 1 applied to an image-forming apparatus. FIG. 1A is a cross-sectional view taken along an XY plane, FIG. 1B is a cross-sectional view taken along a ZY plane, and FIG. 10 is a front view from an X direction of the lens array 105. The lens array 105 of Example 1 is configured to condense a plurality of light beams emitted from a light source 101 arranged on an object plane onto a light-receiving surface (image-forming surface) 106 arranged at an image plane. The light source 101 includes a plurality of light-emitting elements arranged equidistantly from each other in the first direction (Y-direction). A light emitting diode (LED), an organic EL element (organic light-emitting element), or a laser diode (LD) may be used for each of the light-emitting elements. The lens array 105 includes an image-forming unit 102 as a first image-forming unit, an image-forming unit 104 as a second image-forming unit, and a light-shielding portion 103. In Example 1, a photosensitive member such as a photosensitive drum is arranged on the light-receiving surface 106.

As illustrated in FIGS. 1A to 1C, the image-forming units 102 and 104 each have a configuration in which two lens rows, each lens row including a plurality of the lens portions 105a, are arranged equidistantly in a second direction (Z direction). The plurality of lens portions 105a include lens surfaces of the lens array; these lens surfaces included in the image-forming unit 102 and the image-forming unit 104 are arranged along an axis symmetry in a direction of optical axes (in the X-direction) of the lens portions 105a. As illustrated in FIG. 10, a lens row on an upper stage and a lens row on a lower stage in the second direction are arrayed so that surface vertexes of the respective lens portions 105a are shifted in the first direction (in a zigzag pattern). For the sake of simplification, the lens portions 105a on the lower row in the second direction (Z-direction) are omitted in FIG. 1A. The light-shielding portion 103 is provided with a plurality of apertures that allow passage of only light beams involved in image formation from among light beams passing through the image-forming unit 102, and shield stray light beams which do not contribute to the image formation by portions other than the apertures.

As illustrated in FIG. 1A, in a first cross section (an XY cross section along an XY plane) parallel to the first direction (Y-direction) and to the direction of the optical axes of the lens portions 105a (X-direction), a light beam emitted from a certain light-emitting element of the light source 101 enters a plurality of lens surfaces of the image-forming unit 102. The image-forming unit 102 condenses the light beam emitted from the light source 101 once onto an intermediate image-forming surface A (intermediate image plane). Here, the intermediate image-forming surface A is a virtual plane on which the image-forming unit 102 forms an intermediate image of the light source 101 located at the object plane. That is, the image-forming unit 102 provides a function for intermediate image formation of the object plane, whereby an intermediate image is formed at a substantially intermediate position between the light source 101 and the light-receiving surface 106. The light beams condensed once onto the intermediate image-forming surface A are collected by respective lens surfaces of the image-forming unit 104, and are further condensed onto the light-receiving surface 106 to form a final image. In other words, an image of the light source 101 is formed on the light-receiving surface 106 by the image-forming unit 104 (i.e., the intermediate image is re-imaged onto the light-receiving surface 106).

As illustrated in FIG. 1B, in a second cross section (a ZX cross section along the ZX plane) perpendicular to the first direction, light beams emitted from the light-emitting elements of the light source 101 are condensed once onto the intermediate image-forming surface A, and then are condensed again onto the light-receiving surface 106. In FIGS. 1A and 1B, only several representative light beams are illustrated. In this manner, the lens array 105 in Example 1 is a system forming first an intermediate image of the light-emitting elements of the light source 101 at the intermediate image-forming surface A (intermediately in the XY cross section and the ZX cross section), and then forming an erected one to one image on the light-receiving surface 106. Therefore, the lens array 105 may be considered as an erecting one to one image-forming system. More specifically, the lens array 105 may be considered an optical system having an intermediate image plane at the intermediate image-forming surface A, and conjugate optical planes located respectively at the light source 101 and the light-receiving surface 106.

Various characteristics of the lens array 105 of Example 1 are summarized in Table 1 shown below.

TABLE 1
CONFIGURATION

| | | |
|---|---|---|
| RESOLUTION | dpi | 600 |
| WAVELENGTH | λ (nm) | 780 |
| REFRACTIVE INDEX | nd | 1.492 |
| Fno IN FIRST CROSS SECTION | Fno_m | 2.52 |
| Fno IN SECOND CROSS SECTION | Fno_s | 2.52 |
| INTERMEDIATE IMAGE-FORMING | βm | 0.43 |
| MAGNIFICATION IN | | |
| FIRST CROSS SECTION | | |
| INTERMEDIATE IMAGE-FORMING | βs | 0.44 |
| MAGNIFICATION IN | | |
| SECOND CROSS SECTION | | |
| ARRAY PITCH OF LENS PORTIONS | Pm | 1.0 |
| IN FIRST DIRECTION | (mm) | |
| ARRAY PITCH OF LENS PORTIONS | Ps (mm) | 0.866 |
| IN SECOND DIRECTION | | |
| NUMBER OF LENS PORTIONS | Nm | 221 |
| ARRAYED IN FIRST DIRECTION | | |
| NUMBER OF LENS PORTIONS | Ns | 2 |
| ARRAYED IN SECOND DIRECTION | | |

EFFECTIVE DIAMETER

| | | |
|---|---|---|
| LENS SURFACE 102a | D1 | 0.9 |
| | (mm) | |
| LENS SURFACE 102b | D2 | 0.9 |
| | (mm) | |
| LENS SURFACE 104a | D3 | 0.9 |
| | (mm) | |
| LENS SURFACE 104b | D4 | 0.9 |
| | (mm) | |

ARRANGEMENT

| | | |
|---|---|---|
| DISTANCE BETWEEN LIGHT SOURCE | d1 (mm) | 2.06 |
| 101 AND LENS SURFACE 102a | | |
| DISTANCE BETWEEN LENS ANGLE | d2 (mm) | 0.95 |
| 102a AND LENS ANGLE 102b | | |
| DISTANCE BETWEEN LENS ANGLE | d3 (mm) | 1.23 |
| 102b AND LENS ANGLE 104a | | |
| DISTANCE BETWEEN LENS ANGLE | d4 (mm) | 0.95 |
| 104a AND LENS ANGLE 104b | | |
| DISTANCE BETWEEN LENS | d5 (mm) | 2.06 |
| ANGLE 104b AND LIGHT | | |
| RECEIVING PORTION 106 | | |
| THICKNESS OF LIGHT SHIELDING | d (mm) | 1.45 |
| PORTION 103 | | |

ASPHERICAL SHAPE

| LENS SURFACE | | LENS SURFACE | |
|---|---|---|---|
| 102a | | 104b | |
| R | 0.4922 | R | −0.4922 |
| k | −3.5737 | k | −3.5737 |
| A4 | 1.0864 | A4 | −1.0864 |
| A6 | −2.1273 | A6 | 2.1273 |
| A8 | 7.1383 | A8 | −7.1383 |
| A10 | −6.6823 | A10 | 6.6823 |
| LENS SURFACE | | LENS SURFACE | |
| 102b | | 104a | |
| R | 0 | R | 0 |
| k | 0 | k | 0 |
| B10 | −0.9484 | B10 | 0.9484 |
| B20 | 0.1903 | B20 | −0.1903 |
| B30 | 19.4975 | B30 | −19.4975 |
| B40 | −117.3667 | B40 | 117.3667 |
| B50 | 268.9637 | B50 | −268.9637 |
| B01 | −0.9118 | B01 | 0.9118 |
| B11 | −0.5288 | B11 | 0.5288 |
| B21 | 50.2657 | B21 | −50.2657 |
| B31 | −407.4755 | B31 | 407.4755 |
| B41 | 1185.4172 | B41 | −1185.4172 |
| B02 | −0.0997 | B02 | 0.0997 |
| B12 | 72.5133 | B12 | −72.5133 |
| B22 | −657.5698 | B22 | 657.5698 |
| B32 | 2596.8427 | B32 | −2596.8427 |
| B03 | 19.0907 | B03 | −19.0907 |
| B13 | −572.9391 | B13 | 572.9391 |
| B23 | 2580.2042 | B23 | −2580.2042 |
| B04 | −114.0655 | B04 | 114.0655 |
| B14 | 1604.1163 | B14 | −1604.1163 |
| B05 | 254.0612 | B05 | −254.0612 |

Here, description of the shapes of respective lens surfaces will be given assuming that an intersection point between each of the lens portions of the lens array 105 and an optical axis (X-axis) of the lens array is an origin point x, an axis orthogonal to the optical axis in the first direction is a Y-axis direction, and an axis orthogonal to the optical axis in the second direction is a Z-axis. Lens surfaces 102a of the image-forming unit 102 and lens surfaces 104b of the image-forming unit 104 are formed into a rotationally symmetric aspherical surface, and the aspherical surface shape thereof is expressed by the following expression (1).

$$x = \frac{\frac{{y}^{2} + {z}^{2}}{R}}{1 + \sqrt{1 - ( 1 + k ) {( \frac{\sqrt{{y}^{2} + {z}^{2}}}{R} )}^{2}}} + {\sum }_{i = 1}^{8} {A}_{2 i} {\sqrt{{y}^{2} + {z}^{2}} }^{2 i} \qquad ( 1 )$$

where, R is a radius of curvature, A₂ᵢ (i=1, 2, 3, 4, 5, . . . ) are aspherical surface coefficients, k is a eccentricity, and x, y, and z are coordinates.

Lens surfaces 102b of the image-forming unit 102 and lens surfaces 104a of the image-forming unit 104 are formed into an anamorphic aspherical surface, and the aspherical surface shape thereof is expressed by the following expression (2).

$$x = \frac{\frac{{y}^{2} + {z}^{2}}{R}}{1 + \sqrt{1 - ( 1 + k ) {( \frac{\sqrt{{y}^{2} + {z}^{2}}}{R} )}^{2}}} + {\sum }_{i = 0}^{8} {\sum }_{j = 0}^{8} {B}_{ij} {y}^{2 i} {z}^{2 j} \qquad ( 2 )$$

where, R is the radius of curvature, B₂ᵢⱼ (i=0, 1, 2, 3, 4, 5, . . . , j=0, 1, 2, 3, 4, 5, . . . ) are aspherical surface coefficients, k is a eccentricity, and x, y, and z are coordinates.

Given the above-defined parameters for the surface shape of lens surfaces 102b of the image-forming unit 102 and lens surfaces 104a of the image-forming unit 104, a relationship between light use efficiency and an image-forming performance of the lens array 105 will now be described.

In general, in order to increase the light use efficiency of the lens array, methods of increasing the light amount that the respective lens surfaces introduce by increasing the numerical aperture (NA) of each of the lens surfaces or by reducing a focal distance of each of the lenses are conceivable. However, when these methods are used, an aberration of the lens array (specifically, the field curvature and the astigmatic difference) is increased, which may result in deterioration of image-forming performance.

As a comparative example, a case where every lens surface of the lens array 105 of Example 1 is formed of a rotationally symmetrical aspherical surface, that is, a case where the lens surface 102b of the image-forming unit 102 and the lens surface 104a of the image-forming unit 104 are also formed into a rotationally symmetrical aspherical surfaces will be described. The NA and the focal distance of the lens array according to the comparative example are assumed to be the same as those of the lens array 105 of Example 1.

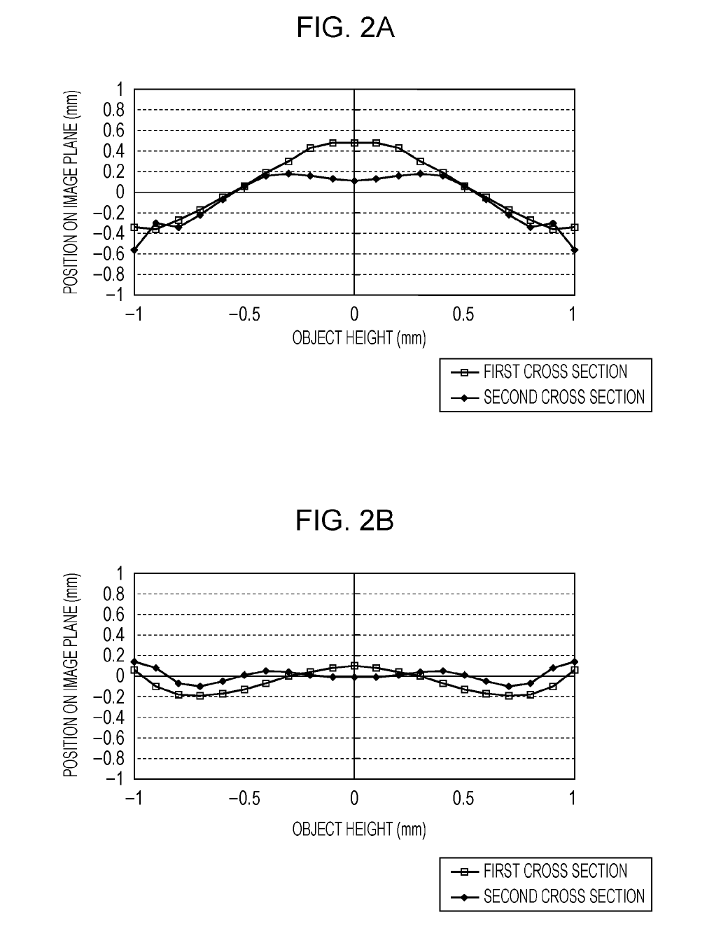

FIG. 2A shows field curvatures in the first cross section passing through a surface vertex and in the second cross section passing through the surface vertex of the lens array of the comparative example. In FIG. 2A, the field curvatures of a real image plane, but not of a paraxial image plane with respect to the respective object heights are plotted. As understood from FIG. 2A, in the lens array of the comparative example, a field curvature of 0.84 mm is generated in the first cross section passing through the surface vertex, and a field curvature (p−p(maximum value−minimum value) of the position on the image plane) of 0.74 mm is generated in the second cross-section passing through the surface vertex. Also, an astigmatic difference of 0.36 mm is generated at an object height of 0.

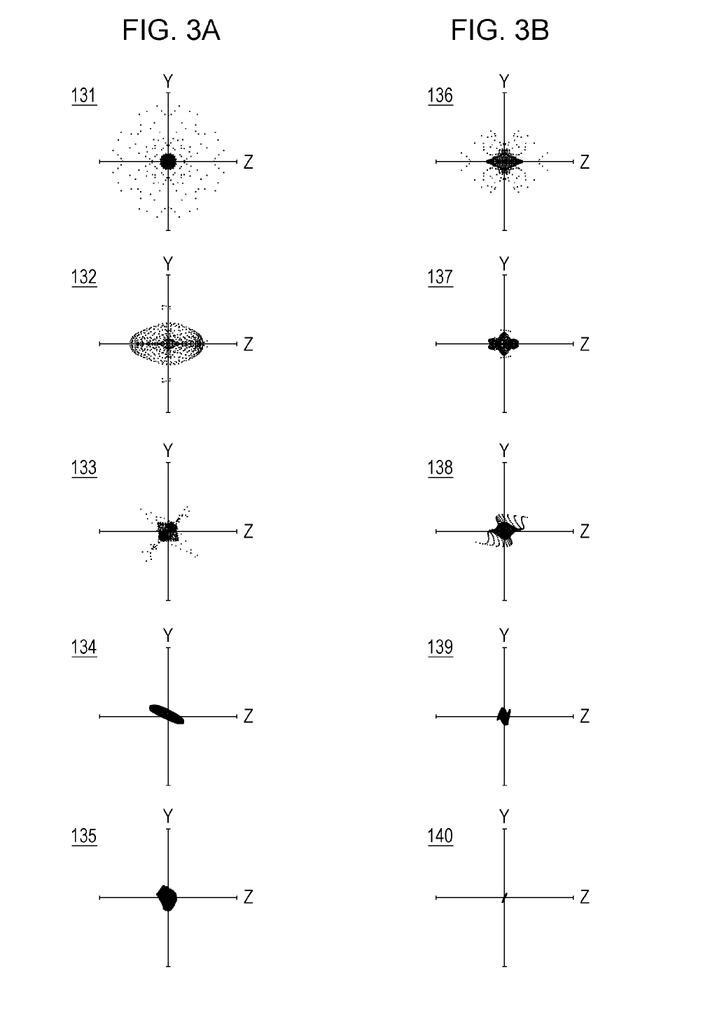

FIG. 3A shows point image distributions at respective object heights of the lens array of the comparative example. Here, a coordinate of an intersection point between an optical axis of a certain lens array and a plane parallel to the first direction and the second direction (YZ plane) is defined as (Y, Z)=(0, 0). In FIG. 3A, reference numerals 131, 132, 133, 134 and 135 denote point image distributions at (y, z) coordinates of (0, 0), (0, 0.433), (0.5, 0.433), (0.9, 0.433), and (1.0, 0.433) respectively in this order. It should be understood that the image-forming performance of the lens array of the comparative example (reference 131) is particularly lower than the point image distribution 132 at an on-axis object height and the point image distribution 135 at the most-off-axis object height.

Therefore, in the lens array 105 of Example 1, the lens surface 102b of the image-forming unit 102 and the lens surface 104a of the image-forming unit 104 are formed into an anamorphic surface as shown in Table 1, whereby the field curvature and the astigmatic difference are reduced while increasing the light use efficiency. An effect of the lens array 105 of Example 1 will be described in detail below.

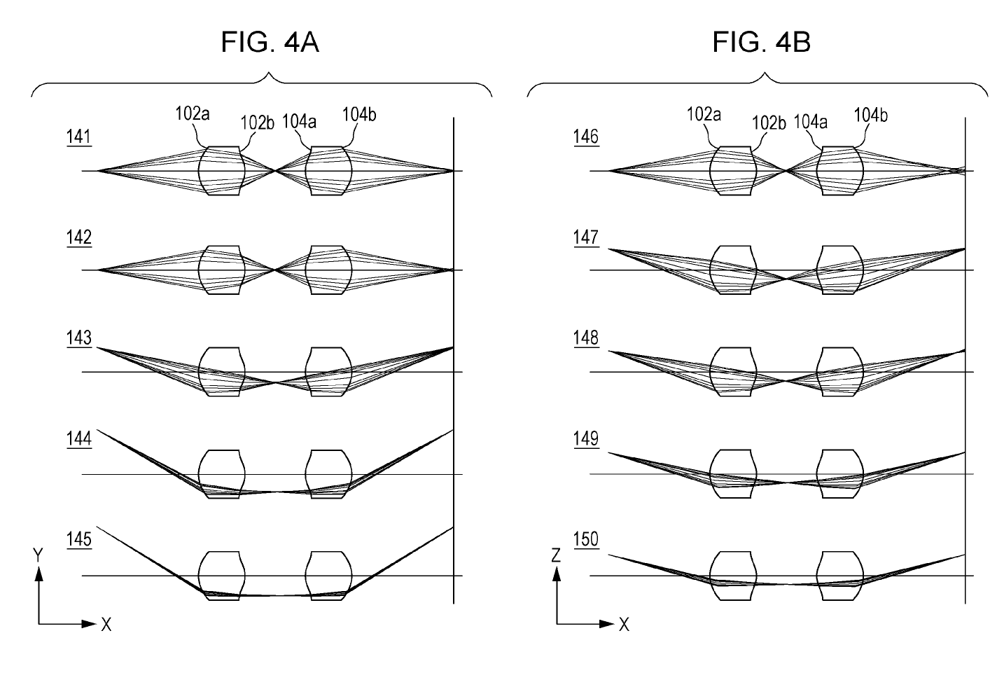

FIG. 4A illustrates optical paths of the light beams from the respective object heights passing through the surface vertex in the first cross section, and FIG. 4B illustrates optical paths of the same optical paths passing through the surface vertex in the second cross section. In FIGS. 4A and 4B, only a pair of lens portions of the image-forming units 102 and 104 opposing each other are illustrated for the sake of simplification, and the lens portions on the lower rows in the second direction are omitted. Reference numerals 141, 142, 143, 144 and 145 in FIG. 4A denote optical paths of the light beams from the light-emitting elements at coordinates of (0, 0), (0, 0.433), (0.5, 0.433), (0.9, 0.433), and (1.0, 0.433) respectively in this order. As will be understood from FIGS. 4A and 4B, incident positions and outgoing positions of the respective light beams with respect to the respective lens surfaces change as it goes from on-axis (142 or 147) toward off-axis (145 or 150) (as an angle of view of the light beam increases).

Here, when respective point distributions from 141 to 145 (or 146 to 150) are compared, the difference of the incident positions and the outgoing positions of the light beams are the largest at the lens surfaces 102b and 104a. In other words, it can be said that the light beams of the respective angles of view are the most apart from each other at the lens surfaces 102b and 104a, which are the closest to the intermediate image-forming surface A. Therefore, according to Example 1, by forming each of the lens surfaces 102b and 104a closest to the intermediate image-forming surface A into an anamorphic aspherical surface, the field curvatures from one angle of view to another may be desirably corrected.

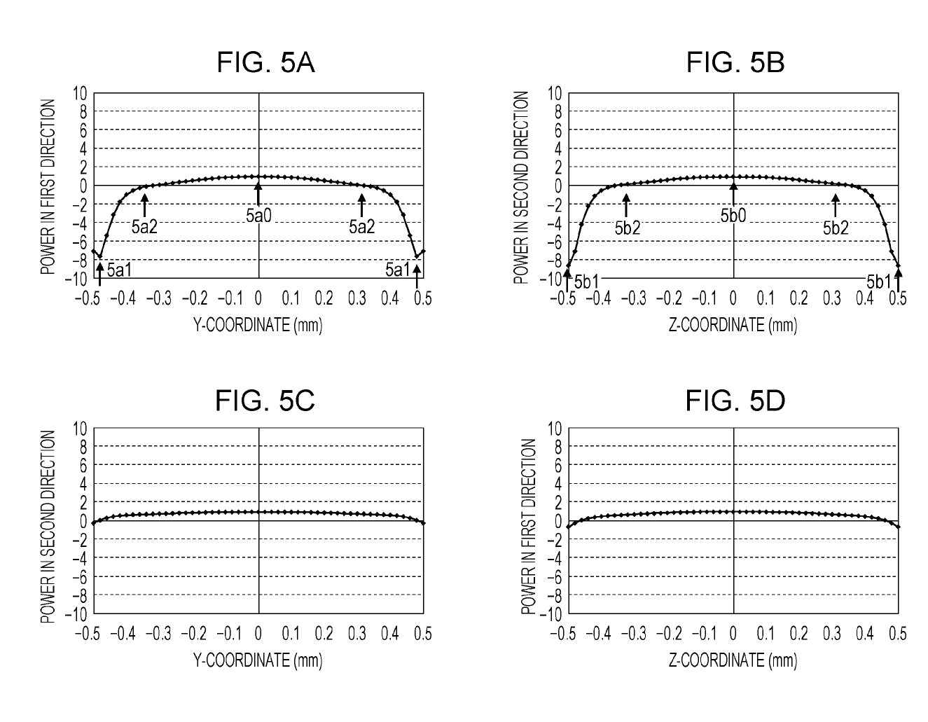

As shown in FIGS. 5A to 5D, the lens surface 102b (104a) has a shape whose power changes locally from a vicinity of the surface vertex (on-axis) toward the end portions (off-axis). The power of each of the lens portions may be considered to be equivalent to a second derivative value of the cross-sectional shape of the lens surface. As shown in FIG. 5A, the power in the first direction in the vicinity of a surface vertex (point 5a0) is 0.93 within the first cross section passing through the surface vertex, and the power in the first direction at end portions (points 5a1) of an effective area in the first direction are −7.68. As shown in FIG. 5B, the power in the second direction in the vicinity of a surface vertex (point 5b0) is 0.90 within the second cross section passing through the surface vertex, and the power in the second direction at end portions (points 5b2) of the effective area in the second direction is −8.63.

In this manner, the shape of the lens surface 102b (104a) has a shape in which the power is smaller at the end portions with respect to the power in the vicinity of the surface vertex in the first cross section passing through the surface vertex and the second cross section passing through the surface vertex so as to correct the field curvature. As shown in FIG. 5A, the power is increased on the outside of the effective area (outside of the point 5a1). However, the effect of this disclosure is achieved as long as the lens surface 102b (104a) has a shape in which the power decreases from the vicinity of the surface vertex toward the end portions in the effective area. The lens surface 102b (104a) has a cross sectional shape in which a point 5a2 and a point 5b2 where the power in the first direction becomes zero exist both in the first cross section passing through the surface vertex and the second cross section passing through the surface vertex as shown in FIGS. 5A and 5B.

As shown in FIG. 5C, the power in the second direction in the local region along the first direction changes from the vicinity of the surface vertex toward the end portions (in the first direction). As will be apparent when comparing FIG. 5A and FIG. 5C, the amount of change of the power in the first direction in the local region along the first direction is set to be larger than the amount of change of the power in the second direction in the local region along the first direction. As shown in FIG. 5D, the power in the first direction in a local region along the second direction changes from the vicinity of the surface vertex toward the end portions (in the second direction). As will be apparent when comparing FIG. 5B and FIG. 5D, the amount of change of the power in the second direction in the local region along the second direction is set to be larger than the amount of change of the power in the first direction in the local region along the second direction. With the lens surface 102b (104a) having the shape as described above, the astigmatic difference generated for each angle of view is reduced.

FIG. 2B shows the field curvatures in the first cross section passing through the surface vertex and the second cross section passing through the surface vertex of the lens array 105 of Example 1. It is understood from FIG. 2B that a field curvature of 0.30 mm is generated in the first cross section passing through the surface vertex, and a field curvature of 0.24 mm is generated in the second cross section passing through the surface vertex in Example 1, which are significantly lower than the field curvature of the comparative example shown in FIG. 2A. It is understood from FIG. 2B that an astigmatic difference of 0.11 is generated at an object height of 0 in Example 1, which is significantly lower than the astigmatic difference of the comparative example shown in FIG. 2A.

Consequently, the point image distributions at the respective object heights of the lens array 105 of Example 1 are as shown in FIG. 3B. Reference numerals from 136 to 140 in FIG. 3B respectively donate point image distributions at object heights corresponding to point image distributions 131 to 135 of the comparative example shown in FIG. 3A. When comparing FIG. 3A and FIG. 3B and reviewing specifically the point image distribution 137 at the on-axis object height and the point image distribution 140 at the most-off-axis object height, it is understood that the image-forming performance of the lens array 105 of Example 1 is better than that of the comparative example.

When manufacturing the lens array 105 by injection molding (mold forming), mirror surfaces corresponding to the respective lens surfaces (concave surfaces when the lenses have a convex shape) need to be formed in a die by a tool such as a rotated bite. However, a reduction of a turning radius of the bite as the tool is limited, and hence the mirror surfaces having a radius equal to or smaller than the turning radius cannot be formed, which is a constraint in molding the lens surface. Accordingly, in Example 1, the lens surfaces 102b and 104a are designed so that radii of curvature R (local radii R) thereof become 0.2 mm or larger in a region having a positive power. Specifically, the smallest radius of curvature R of the lens surfaces 102b and 104a of Example 1 is 0.52 mm, which achieves a lens shape suitable for the die machining.

As described above, in the lens array 105 of Example 1, the light use efficiency is set to be a high value. The lens array 105 is configured so as to satisfy the following conditional expression (3).

Fno≦K₁×βₘ+K₂ (3)

where Fno is an F number of a single lens portion 105a of the image-forming unit 102, βm is a paraxial image-forming magnification (intermediate image-forming magnification) of the image-forming unit 102 in the first cross section when forming an intermediate image of the object plane on the intermediate image-forming surface A. Here, K₁ and K₂ are coefficients determined by the conditions of light beams incident on the lens portion such as the Fresnel reflection, the light use efficiency, and an angle-intensity distribution of the light source, and determine a combination of Fno and βm which achieves a predetermined light use efficiency.

For example, when an LED light source having a Lambert's angle-intensity distribution is used, if the light use efficiency is set to 5%, K₁=−13.14, K₂=8.88 are established, and the values of K₁ and K₂ are substituted in the expression (3), the following expression (4) is obtained.

Fno≦−13.14×βₘ+8.88 (4)

If the light use efficiency is set to 7%, K₁=−13.75, K₂=8.5 are established, and the values of K₁ and K₂ are substituted in the expression (3), the following expression (5) is obtained.

Fno≦−13.75×βₘ+8.57 (5)

In Example 1, the F number Fno of each of the lens portions 105a of the image-forming unit 102 is 2.52, and the intermediate image-forming magnification βm is 0.43, so that it is understood that the expression (4) and the expression (5) are satisfied.

As described thus far, according to the lens array 105 of Example 1, by forming each of the lens surfaces 102b and 104a closest to the intermediate image-forming surface A into an anamorphic aspherical surface, the field curvatures and the astigmatic difference may be corrected desirably while increasing the light use efficiency.

### Example 2

Example 2 of this disclosure will be described below. In Example 2, the same or equivalent components as those of Example 1 are denoted by the same reference numerals and description thereof will be simplified or omitted. In Example 2, the field curvature and the astigmatic difference are desirably corrected by arranging more lens rows than that in Example 1 to constitute a lens array.

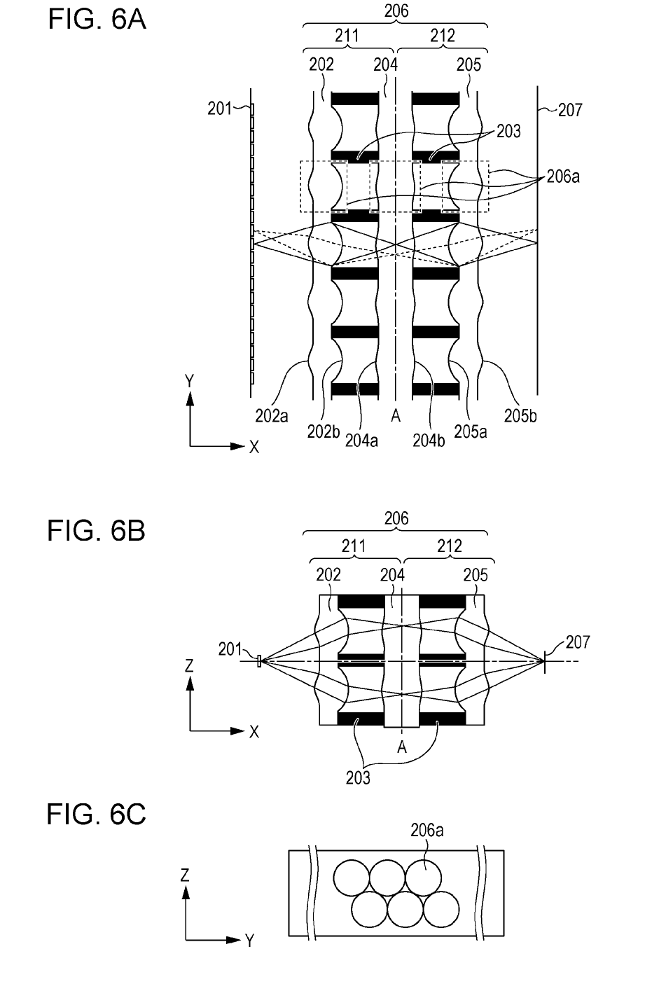

FIGS. 6A to 6C are schematic drawings illustrating a principal portion of a lens array 206 of Example 2. FIG. 6A is a cross-sectional view taken along an XY plane, FIG. 6B is a cross-sectional view taken along a ZY plane, and FIG. 6C is a front view from an X direction. The lens array 206 of Example 2 is configured to condense a plurality of light beams emitted from a light source 201 including a plurality of light-emitting elements on a light-receiving surface 207. The lens array 206 includes an image-forming unit 211 as a first image-forming unit, an image-forming unit 212 as a second image-forming unit, and a light-shielding portion 203.

Here, unlike the lens array 105 of Example 1, the lens array 206 includes three lens rows 202, 204, and 205. In Example 2, a portion from the object plane (light source 201) to the intermediate image-forming surface A corresponds to the first image-forming portion 211, and a portion from the intermediate image-forming surface A to the image plane (light-receiving surface 207) corresponds to the second image-forming portion 212. The image-forming portion 211 and the image-forming portion 212 have the same lens surface, and are arranged so as to be symmetry with respect to the intermediate image-forming surface A. Respective lens portions 206a are arrayed in a zigzag pattern as illustrated in FIG. 6C. However, for the sake of simplification, the lens portions 206a on the lower row in the second direction are omitted in FIG. 6A.

The lens array 206 of Example 2, in the same manner as the lens array 105 of Example 1, is also an erecting one to one image-forming system imaging the light-emitting elements of the light source 201 intermediately in an XY cross section and a ZX cross section, and then re-imaging the formed intermediate image again on the light-receiving surface 207.

Various characteristics of the lens array 206 of Example 2 are summarized in Table 2 set forth below.

TABLE 2
CONFIGURATION

| | | |
|---|---|---|
| RESOLUTION | dpi | 600 |
| WAVELENGTH | λ (nm) | 780 |
| REFRACTIVE INDEX | nd | 1.492 |
| Fno IN FIRST CROSS SECTION | Fno_m | 4.50 |
| Fno IN SECOND CROSS SECTION | Fno_s | 4.50 |
| INTERMEDIATE IMAGE-FORMING | βm | 0.31 |
| MAGNIFICATION IN FIRST | | |
| CROSS SECTION | | |
| INTERMEDIATE IMAGE-FORMING | βs | 0.31 |
| MAGNIFICATION IN SECOND | | |
| CROSS SECTION | | |
| ARRAY PITCH OF LENS PORTIONS | Pm | 1.0 |
| IN FIRST DIRECTION | (mm) | |
| ARRAY PITCH OF LENS PORTIONS | Ps (mm) | 0.866 |
| IN SECOND DIRECTION | | |
| NUMBER OF LENS PORTIONS | Nm | 221 |
| ARRAYED IN FIRST DIRECTION | | |
| NUMBER OF LENS PORTIONS | Ns | 2 |
| ARRAYED IN SECOND DIRECTION | | |

EFFECTIVE DIAMETER

| | | |
|---|---|---|
| LENS SURFACE 202a | D1 | 0.9 |
| | (mm) | |
| LENS SURFACE 202b | D2 | 0.9 |
| | (mm) | |
| LENS SURFACE 204a | D3 | 0.9 |
| | (mm) | |
| LENS SURFACE 204b | D4 | 0.9 |
| | (mm) | |
| LENS SURFACE 205a | D3 | 0.9 |
| | (mm) | |
| LENS SURFACE 205b | D4 | 0.9 |
| | (mm) | |

ARRANGEMENT

| | | |
|---|---|---|
| DISTANCE BETWEEN LIGHT | d1 (mm) | 3.00 |
| SOURCE 201 AND | | |
| LENS SURFACE 202a | | |
| DISTANCE BETWEEN LENS ANGLE | d2 (mm) | 1.05 |
| 202a AND LENS ANGLE 202b | | |
| DISTANCE BETWEEN LENS ANGLE | d3 (mm) | 0.76 |
| 202b AND LENS ANGLE 204a | | |
| DISTANCE BETWEEN LENS ANGLE | d4 (mm) | 0.90 |
| 204a AND LENS ANGLE 204b | | |
| DISTANCE BETWEEN LENS ANGLE | d5 (mm) | 0.76 |
| 204b AND LENS ANGLE 205a | | |
| DISTANCE BETWEEN LENS ANGLE | d6 (mm) | 1.05 |
| 205a AND LENS ANGLE 205b | | |
| DISTANCE BETWEEN LENS ANGLE | d7 (mm) | 3.00 |
| 205b AND LIGHT | | |
| RECEIVING PORTION 207 | | |
| THICKNESS OF LIGHT | d (mm) | 0.95 |
| SHIELDING PORTION 203 | | |

ASPHERICAL SHAPE

| LENS SURFACE | | LENS SURFACE | |
|---|---|---|---|
| 202a | | 205b | |
| R | 1.9138 | R | −1.9138 |
| k | −18.0622 | k | −18.0622 |
| A4 | −1.2420 | A4 | 1.2420 |
| A6 | 3.8536 | A6 | −3.8536 |
| A8 | −62.6064 | A8 | 62.6064 |
| A10 | 0 | A10 | 0 |
| LENS SURFACE | | LENS SURFACE | |
| 202b | | 205a | |
| R | −0.4802 | R | 0.4802 |
| k | −0.4579 | k | −0.4579 |
| A4 | 0.7740 | A4 | −0.7740 |
| A6 | −0.7659 | A6 | −0.7659 |
| A8 | 2.7524 | A8 | −2.7524 |
| A10 | 0 | A10 | 0 |
| LENS SURFACE | | LENS SURFACE | |
| 204a | | 204b | |
| R | 100 | R | -100 |
| k | −36314.221 | k | −36314.221 |
| B10 | 0 | B10 | 0 |
| B20 | 1.5433 | B20 | −1.5433 |
| B30 | −6.0063 | B30 | 6.0063 |
| B40 | 0 | B40 | 0 |
| B50 | 0 | B50 | 0 |
| B01 | 0.0132 | B01 | −0.0132 |
| B11 | 4.0691 | B11 | −4.0691 |
| B21 | −11.1429 | B21 | 11.1429 |
| B31 | 255.3177 | B31 | −255.3177 |
| B41 | −935.5809 | B41 | 935.5809 |
| B02 | 1.5433 | B02 | −1.5433 |
| B12 | −11.2245 | B12 | 11.2245 |
| B22 | −497.7506 | B22 | 497.7506 |
| B32 | 0 | B32 | 0 |
| B03 | −6.0063 | B03 | 6.0063 |
| B13 | 0 | B13 | 0 |
| B23 | 0 | B23 | 0 |
| B04 | 0 | B04 | 0 |
| B14 | 0 | B14 | 0 |
| B05 | 0 | B05 | 0 |

Lens surfaces 202a and 202b of the image-forming unit 211 and lens surfaces 205a and 205b of the image-forming unit 212 have a rotationally symmetric aspherical surface, and the aspherical surface shape thereof is expressed by the expression (1) given above. A lens surface 204a of the image-forming portion 211 and a lens surface 204b of the image-forming portion 212 have an anamorphic aspherical surface, and the aspherical surface shape thereof is expressed by the expression (2) given above.

An effect of the lens array 206 of Example 2 will be described in detail below.

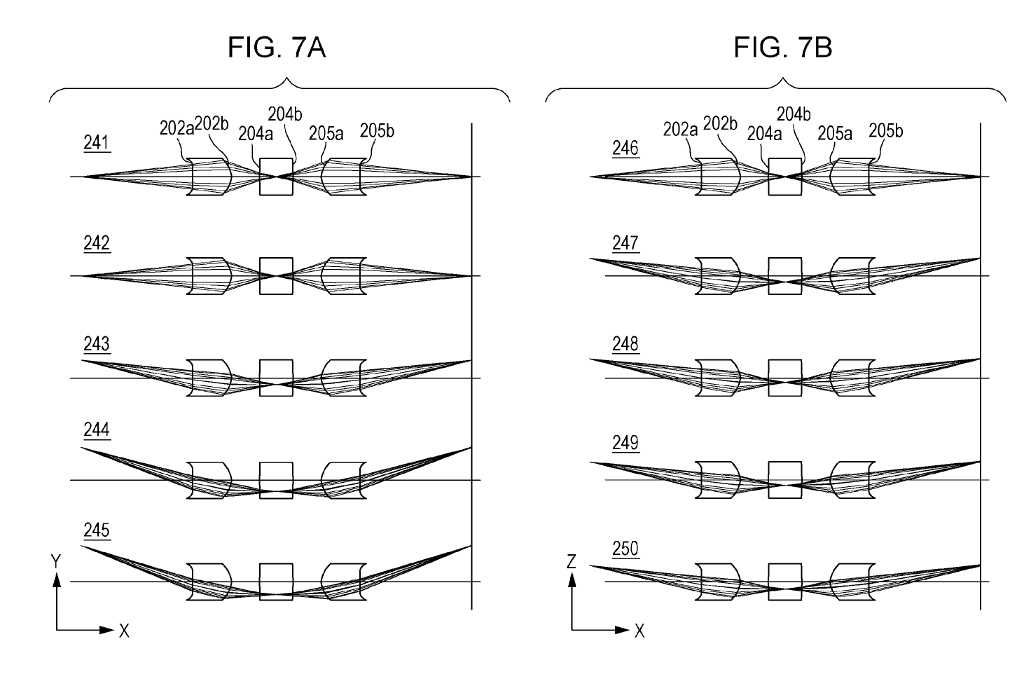

FIG. 7A illustrates optical paths of the light beams from the respective object heights passing through the surface vertex in the first cross section, and FIG. 7B illustrates optical paths of the same passing through the surface vertex in the second cross section. In FIGS. 7A and 7B, only one lens portion for each of the lens rows 202, 204, and 205 is illustrated for the sake of simplification, and the lens portions on the lower rows in the second direction are omitted. Reference numerals 241 to 245 (246 to 250 in FIG. 7B) in FIG. 4A respectively denote optical paths of the light beams from the light-emitting elements at coordinates of (0, 0), (0, 0.433), (0.5, 0.433), (0.9, 0.433), and (1.0, 0.433) in this order.

In Example 2, with the provision of the lens row 204, the lens surfaces 204a and 204b may be arranged at positions closer to the intermediate image-forming surface A than the lens surfaces 102b and 104a of Example 1. Accordingly, as is understood from FIGS. 7A and 7B, the light beams from the respective object heights in the lens surfaces 204a and 204b are significantly separated from those of the lens surfaces 102b and 104a of Example 1. Therefore, by forming each of the lens surfaces 204a and 204b closest to the intermediate image-forming surface A in the lens array 206 into an anamorphic aspherical surface as shown in Table 2, the field curvatures from one angle of view to another may be corrected further desirably.

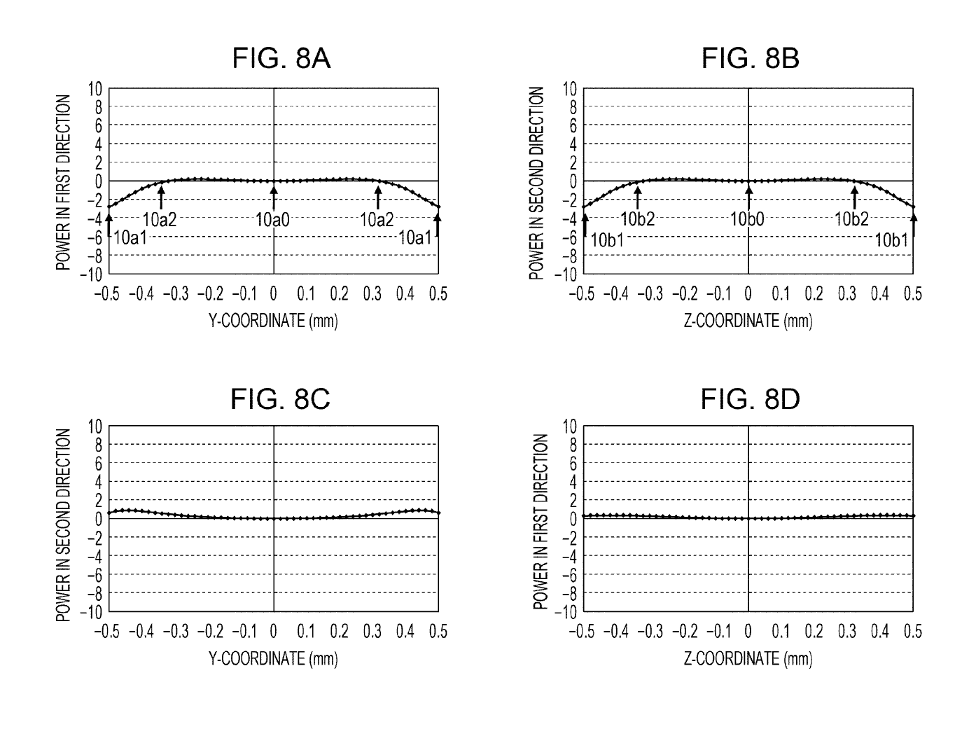

As shown in FIGS. 8A to 8D, the lens surface 204a (204b) has a shape whose power decreases from a vicinity of the surface vertex (on-axis) toward the end portions (off-axis) in the same manner as those in Example 1. As shown in FIG. 8A, the power in the first direction in the vicinity of a surface vertex (point 10a0) is 0.005 within the first cross section passing through the surface vertex, and the power in the first direction at end portions (points 10a1) of the effective area in the first direction is −2.74. As shown in FIG. 8B, the power in the second direction in the vicinity of a surface vertex (point 10b0) is 0.018 within the second cross section passing through the surface vertex, and the power in the second direction at end portions (points 10b1) of the effective area in the second direction is −2.76. The lens surface 202b (205a) has a cross sectional shape in which a point 10a2 and a point 10b2 where the power in the first direction becomes zero exist both in the first cross section passing through the surface vertex and the second cross section passing through the surface vertex as shown in FIGS. 8A and 8B.

As shown in FIGS. 8A and 8C, the amount of change of the power in the first direction in the local region along the first direction is set to be larger than the amount of change of the power in the second direction in the local region along the first direction. As shown in FIGS. 8B and 8C, the amount of change of the power in the second direction in the local region along the second direction is set to be larger than the amount of change of the power in the first direction in the local region along the second direction. With the lens surface 202b (205a) having the shape as described above, the astigmatic difference generated for each angle of view may be reduced.

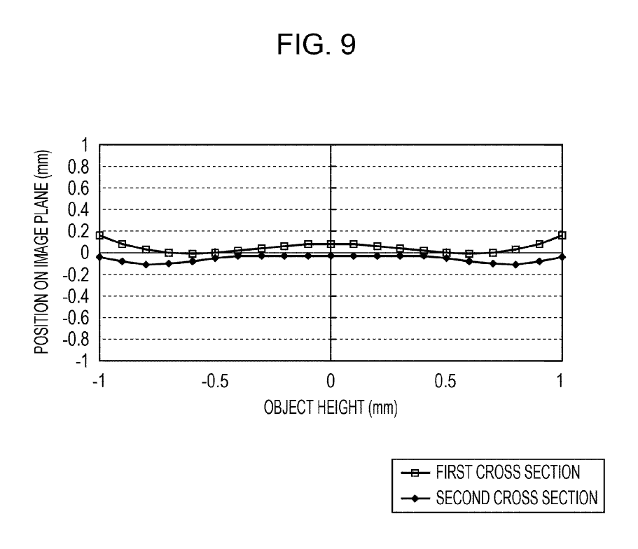

FIG. 9 shows the field curvatures in the first cross section passing through the surface vertex and the second cross section passing through the surface vertex of the lens array 206 of Example 2. From FIG. 9 that a field curvature of 0.17 mm is generated in the first cross section passing through the surface vertex, and a field curvature of 0.08 mm is generated in the second cross section passing through the surface vertex in Example 2. Accordingly, it is understood that the field curvatures in Example 2 are significantly reduced in comparison with the field curvatures of the comparative example and Example 1 shown in FIGS. 2A and 2B. It is understood from FIG. 9 that an astigmatic difference of 0.11 mm is generated at an object height of 0 in Example 1, which is significantly lower than the astigmatic difference in the comparative example shown in FIG. 2A.

Consequently, the point image distributions at the respective object heights of the lens array 206 of Example 2 are as shown in FIG. 10. Reference numerals from 231 to 235 in FIG. 10 respectively donate point image distributions at object heights corresponding to the point image distributions 131 to 135 of the comparative example shown in FIG. 3A. When comparing FIG. 3A and FIG. 10 and reviewing specifically the point image distribution 232 at the on-axis object height and the point image distribution 235 at the most-off-axis object height, it is understood that an image-forming performance of the lens array 206 of Example 2 is better than that of the comparative example.

The smallest local radius R of the lens surfaces 204a and 204b of Example 2 is 0.54 mm, which achieves a lens shape suitable for the die machining. Furthermore, the F number Fno of each of the lens portions 206a of the lens row 202 is 4.5, and the intermediate image-forming magnification βm in the first cross section of the image-forming portion 211 is 0.31, so that it is understood that the expression (4) is satisfied.

As described above, according to the lens array 206 of Example 2, by forming the lens surfaces 204a and 204b which are surfaces closest to the intermediate image-forming surface A into an anamorphic aspherical surface, the field curvature and the astigmatic difference may be corrected while increasing the light use efficiency.

### Image-Forming Apparatus

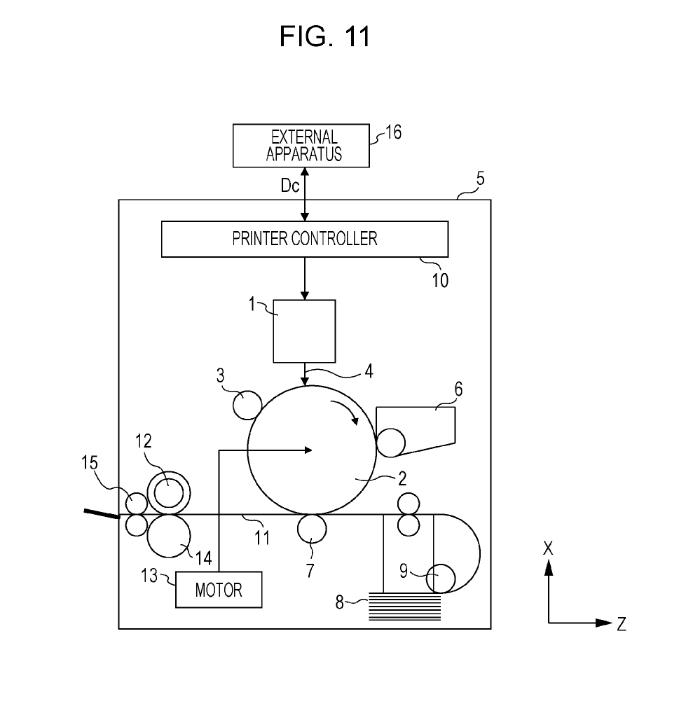

FIG. 11 is a schematic drawing (cross-sectional view taken along a ZX plane) of a principal portion of an image-forming apparatus 5 according to an embodiment of this disclosure. The image-forming apparatus 5 includes an optical apparatus (exposure unit) 1 having any one of lens arrays described in the respective examples given above, and the lens array is arranged so that the second direction matches a secondary scanning direction (Z direction), which is a direction of rotation of a photosensitive drum 2. The image-forming apparatus 5 is connected to an external apparatus 16 such as a personal computer, from which code data Dc is input. The input code data Dc is converted into image signal (dot data) Di by a printer controller 10 in the image-forming apparatus 5. The image signal Di is input to the optical apparatus 1, and exposure light 4 modulated by the optical apparatus 1 according to the image signal Di goes out therefrom and a light-receiving surface (photosensitive surface) of the photosensitive drum 2 is exposed by the exposure light 4. The printer controller 10 performs not only the data conversion as described above, but also control of components in the image-forming apparatus such as a motor 13, described below.

The photosensitive drum 2 as an electrostatic latent image bearing member is rotated by the motor 13 in a direction indicated by an arrow (clockwise) in FIG. 11. In association with the rotation of the photosensitive drum 2, the photosensitive surface of the photosensitive drum 2 moves in the second direction (Z direction) with respect to the exposure light 4. A charging roller 3 configured to charge a surface of the photosensitive drum 2 uniformly is provided above the photosensitive drum 2 so as to be in contact with a surface of the photosensitive surface. Then, the photosensitive surface of the photosensitive drum 2 charged by the charging roller 3 is irradiated with the exposure light 4 by the optical apparatus 1. As described above, the exposure light 4 is modulated on the basis of the image signal Di, and an electrostatic latent image may be formed on the surface of the photosensitive drum 2 by the irradiation thereof with the exposure light 4.

The electrostatic latent image is developed as a toner image by a developing unit 6 disposed in contact with the photosensitive drum 2 on the further downstream side of the position irradiated with the exposure light 4 in the direction of rotation of the photosensitive drum 2. The toner image developed by the developing unit 6 is transferred onto a sheet 11 as a recording material by a transfer device (transfer roller) 7 disposed below the photosensitive drum 2 so as to oppose the photosensitive drum 2. The sheet 11 is stored in a sheet cassette 8 in the front (+Z direction) of the photosensitive drum 2. A sheet feed roller 9 is disposed at an end portion of the sheet cassette 8, and the sheet 11 in the sheet cassette 8 is fed to a path. The sheet 11 may be fed by manual insertion.

The sheet 11 to which the toner image is transferred is conveyed to a fixing device positioned further on the rear (−Z direction) of the photosensitive drum 2. The fixing device includes a fixing roller 12 having a fixing heater (not illustrated) and a press roller 14 disposed so as to be in press contact with the fixing roller 12 in the interior thereof. The fixing device is configured to fix the toner image on the sheet 11 by heating the sheet 11 conveyed from the transfer device 7 while pressurizing by the fixing roller 12 and the press roller 14 thereto. A sheet discharge roller 15 is disposed on the rear of the fixing roller 12, whereby the sheet 11 on which the toner image is fixed is discharged out from the image-forming apparatus.

### Color Image-Forming Apparatus

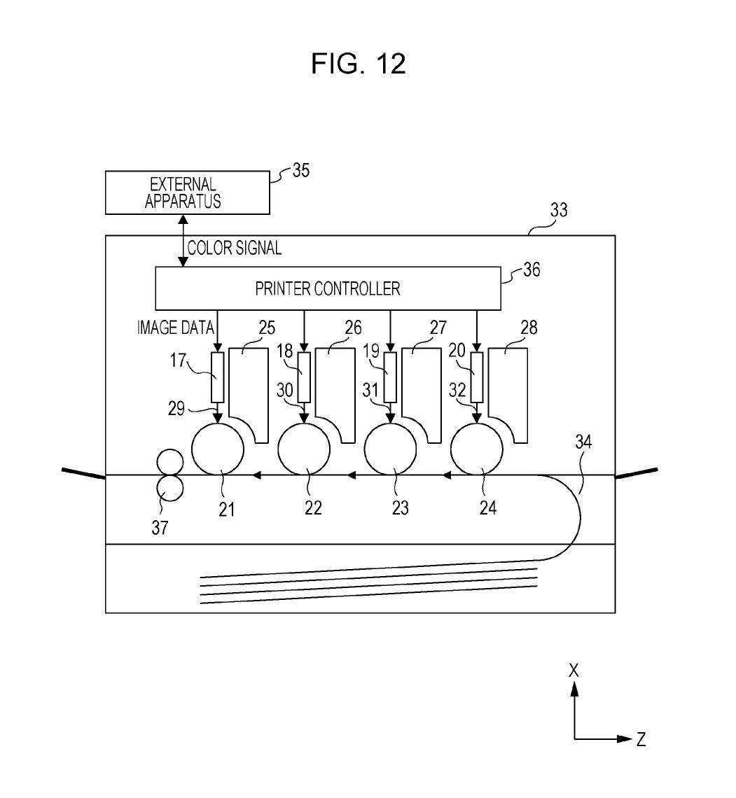

FIG. 12 is a schematic drawing (cross-sectional view taken along the ZX plane) of a principal portion of a color image-forming apparatus 33 according to an embodiment of this disclosure. The color image-forming apparatus 33 is a color image-forming apparatus of a tandem type including four optical apparatuses (exposure units) having any one of lens arrays described in the examples described above arranged in parallel in a line configured to expose the light-receiving surface (photosensitive surface) of the photosensitive drum. In FIG. 12, reference numerals 17, 18, 19, and 20 respectively denote optical apparatuses which constitute any one of the configurations described in the respective examples, reference numerals 21, 22, 23, and 24 respectively denote photosensitive drums as image bearing members, reference numerals 25, 26, 27, and 28 respectively denote developing devices, reference numeral 34 denotes a conveyor belt, and reference numeral 37 denotes a fixing device. Here, the optical apparatuses 17, 18, 19, and 20 are arranged so that the second direction of the lens array matches the secondary scanning direction (Z direction), which is a direction of rotation of the photosensitive drums 21, 22, 23, and 24, respectively.

In FIG. 12, color signals of R (red), G (green), and B (blue) are input from an external apparatus 35 such as a personal computer to the color image-forming apparatus 33. These color signals are converted into image signals (dot data) of C (cyan), M (magenta), Y (yellow), and B (black) by a printer controller 36 in the apparatus. The image signals of the respective colors are input to the corresponding optical apparatuses 17, 18, 19, and 20. The optical apparatuses 17, 18, 19, and 20 emit exposure lights 29, 30, 31, and 32 modulated on the basis of the image signals of the respective colors, respectively, and photosensitive surfaces of the corresponding photosensitive drums 21, 22, 23, and 24 are exposed by the exposure lights.

Subsequently, latent images of the respective colors formed on the photosensitive surfaces of the photosensitive drums 21, 22, 23, and 24 are developed by the developing units 25, 26, 27, and 28, respectively, into toner images of respective colors. The toner images of the respective colors are transferred to a recording material by a transfer device, not illustrated, in an overlapped manner, and then are fixed by the fixing device 37, so that one full color image is formed.

### Image-Reading Apparatus

### Image-Reading Apparatus

An image-reading apparatus including a lens array having any one of configurations described in the respective examples given above and a plurality of light-receiving units is also applicable. In this case, the optical apparatus is constituted by arranging an original on the object plane of the lens array, and arranging a light-receiving sensor (line sensor) such as a CMOS sensor on an image plane (light-receiving surface).

The image-reading apparatus is capable of irradiating an original with an illuminating device including a light source, condensing a plurality of light beams (reflected light or transmitted light) from the original by the lens array, and receiving the condensed light by sensor surfaces of the plurality of light receiving units arranged on the light-receiving surface. By arranging the lens array so that the second direction thereof matches a direction in which a relative position between the original and the lens array is moved by a drive unit (secondary scanning direction), reading of the original in sequence in the secondary scanning direction is achieved.

Examples of the above-described plurality of light-receiving units may include a line sensor such as a CCD sensor or a CMOS sensor. In addition, the image-reading apparatus may be connected to the color image-forming apparatus 33 as the external apparatus 35 described above to constitute a color digital copying machine.

### Modification

While the present invention has been described with reference to exemplary embodiments, it is to be understood that the invention is not limited to the disclosed exemplary embodiments. The scope of the following claims is to be accorded the broadest reasonable interpretation so as to encompass all modifications and equivalent structures and functions.

For example, the image-forming units of the respective examples described above have a configuration in which two rows of the lens portions are arranged in the second direction. However, the image-forming unit may include one row or three or more rows of the lens portions arrayed in the second direction. The lens arrays of Examples 1 and 2 have a configuration in which two or three lens rows are arrayed, respectively. The invention, however, is not limited thereto, and the lens array may include four or more lens rows.

In the respective examples, the shape of the rotationally symmetrical aspherical surface is expressed by the expression (1), and the anamorphic aspherical surface is expressed by the expression (2). The invention, however, is not limited to these expressions, and lens surfaces having an aspherical shape expressed by other expressions are also applicable. Although the lens arrays of the respective examples are of the erecting one to one image-forming system, the erecting image-forming system does not have to be strictly the same magnification as long as the same results (effects) are obtained.

The light source of the respective examples may have a configuration in which the plurality of light-emitting elements are arrayed only in the first direction. However, a configuration in which a plurality of rows of the light-emitting elements are arranged in the second direction, and the plurality of light-emitting elements are arrayed in a zigzag pattern is also applicable. In this configuration, a larger number of light-emitting elements may be arrayed in concentrated masses without considering the spaces between the light-emitting elements adjacent in the first direction, so that the resolution may further be enhanced. In a case where the plurality of the light-emitting elements are arranged in the second direction, the angle of view of the light beams from the respective light emitting elements in the second direction becomes larger, and hence a larger field curvature may result. However, according to the lens array of this disclosure, the field curvature may be corrected desirably also in such a case.

In the respective examples described above, the intermediate image-forming magnification βm in the first cross section and the intermediate image-forming magnification βs in the second cross section of the first image-forming unit are equivalent as shown in Tables 1 and 2. However, the invention is not limited thereto. In other words, a configuration in which the field curvature or the astigmatic difference are corrected not only by applying a power change described above to the lens surface, but also by setting the intermediate image-forming magnification to βm>βs is also applicable. In this case, a configuration of a toric surface having different radii of curvature in the XY cross section and the ZX cross section is also applicable.

The recording density of the image-forming apparatus of the embodiment is not specifically limited. However, when considering the fact that the higher the recording density, the higher image quality is required, this disclosure provides a great benefit in the image-forming apparatus of 1200 dpi or higher.

This application claims the benefit of Japanese Patent Application No. 2012-268544, filed Dec. 7, 2012, which is hereby incorporated by reference herein in its entirety.

What is claimed is:

1. A lens array comprising:
a first image-forming unit having a plurality of lens portions arrayed in a first direction and configured to form an intermediate image of an object at an intermediate image plane; and
a second image-forming unit having a plurality of lens portions arrayed in the first direction and configured to re-image the intermediate image of the object onto a final image plane,
wherein the plurality of lens portions of the first and second image-forming units each have an anamorphic surface on a lens surface closest to the intermediate image plane, and
wherein each anamorphic surface has a shape having a decreased power at end portions as compared to a power in the vicinity of a surface vertex.

2. The lens array according to claim 1, wherein the anamorphic surface has a shape in which an amount of change in power in the first direction from the vicinity of the surface vertex to the end portions in a local region along the first direction is larger than an amount of change in power from the vicinity of the surface vertex to the end portions in a second direction perpendicular to the first direction and perpendicular to a direction of optical axes of the lens portions along the first direction.

3. The lens array according to claim 1, wherein the anamorphic surface has a shape in which an amount of change in power in the second direction from the vicinity of the surface vertex to the end portions in a local region along the second direction perpendicular to the first direction and perpendicular to a direction of optical axes of the lens portions is larger than an amount of change in power in the first direction from the vicinity of the surface vertex to the end portions along the second direction.

4. The lens array according to claim 1, wherein each of the plurality of lens portions of the first image-forming unit satisfies a condition of Expression 1,
Fno≦−13.14×βₘ+8.88
where Fno is an F number and βm is an intermediate image-forming magnification in a cross section parallel to the first direction and parallel to a direction of optical axes of the plurality of lens portions.

5. The lens array according to claim 1, wherein each of the plurality of lens portions of the first image-forming unit has an intermediate image-forming magnification in a cross section parallel to the first direction and parallel to a direction of optical axes of the lens portions larger than an intermediate image-forming magnification in a second cross section perpendicular to the first direction.

6. The lens array according to claim 1, wherein the anamorphic surface has a point where the power in the first direction becomes zero in the local region along the first direction.

7. The lens array according to claim 1, wherein the anamorphic surface has a point where the power in the second direction becomes zero in the local region along the second direction perpendicular to the first direction and perpendicular to a direction of optical axes of the lens portions.

8. The lens array according to claim 1, wherein the anamorphic surface has a positive power in the vicinity of the surface vertex.

9. The lens array according to claim 1, wherein a local diameter of a region having the positive power in the anamorphic surface is equal to or larger than 0.2 mm.

10. The lens array according to claim 1, wherein each of the plurality of image-forming units includes the plurality of lens portions arrayed in the first direction and the second direction perpendicular to the first direction and the direction of the optical axes of the lens portions, and
the plurality of lens portions are arrayed in a plane parallel to the first direction and the second direction in a zigzag pattern.

11. An image-forming apparatus comprising:
a lens array including:
a first image-forming unit having a plurality of lens portions arrayed in a first direction and configured to form an intermediate image of an object at an intermediate image plane; and
a second image-forming unit having a plurality of lens portions arrayed in the first direction and configured to re-image the intermediate image of the object onto a final image plane,
wherein the plurality of lens portions of the first and second image-forming units each have an anamorphic surface on a lens surface closest to the intermediate image plane, and
wherein each anamorphic surface has a shape having a decreased power at end portions in comparison with a power in the vicinity of a surface vertex, and
a light source including a plurality of light-emitting elements arranged on an object plane of the lens array;
a developing unit configured to develop electrostatic latent image formed by the lens array on a photosensitive surface of a photosensitive member arranged on the image plane of the lens array by using a plurality of light beams emitted from the light source into a toner image;
a transfer device configured to transfer the developed toner image to a recording material; and
a fixing device configured to fix the transferred image onto the recording material,
wherein the lens array is arranged so that the second direction perpendicular to the first direction and the direction of optical axes of the lens portions matches a direction of rotation of the photosensitive member.

12. The image-forming apparatus according to claim 11, wherein the plurality of light-emitting elements of the light source are arrayed in a plane parallel to the first direction and the second direction perpendicular to the direction of optical axes of the lens portions in a zigzag pattern.

13. The image-forming apparatus according to claim 11, wherein the plurality of light-emitting elements of the light source are organic light-emitting elements.

14. An image-reading apparatus comprising:
a lens array including:
a first image-forming unit having a plurality of lens portions arrayed in a first direction and configured to form an intermediate image of an object at an intermediate image plane; and
a second image-forming unit having a plurality of lens portions arrayed in the first direction and configured to re-image the intermediate image of the object onto a final image plane,
wherein the plurality of lens portions of the first and second image-forming units each have an anamorphic surface on a lens surface closest to the intermediate image plane, and
wherein each anamorphic surface has a shape having a decreased power at end portions in comparison with a power in the vicinity of a surface vertex, and
an illuminating device configured to irradiate an original;
a plurality of light-receiving portions configured to receive a light beam condensed by the lens array from the original; and
a drive unit configured to move the lens array with respect to the original in the second direction perpendicular to the first direction and the direction of optical axes of the lens portions.
